(19) United States
(12) Patent Application Publication
(10) Pub. No.: US 2004/0069332 A1
(43) Pub. Date: Apr. 15, 2004

(54) Spray arm hub/head for ware washer

(76) Inventor: Forrest L. LeBaron, Twin Falls, ID (US)

Correspondence Address: PEDERSEN & COMPANY, PLLC, P.O. BOX 2666, BOISE, ID, 83701, US

(21) Appl. No.: 10/385,367

(22) Filed: Mar. 7, 2003

Related U.S. Application Data
(60) Provisional application No. 60/363,108, filed on Mar. 7, 2002.

(51) Int. Cl. B08B 3/02; B05B 3/00

(52) U.S. Cl. 134/179; 134/176; 239/225.1; 134/198

(57) ABSTRACT

The invention is a spray arm hub/head for a high-temperature, automatic ware washer. The hub/head sub-assembly of the invention is mounted to the inlet water line via a double ball-bearing coupling that is independent of the hub. The substantially non-enclosed ball-bearing coupling enables the hub/head sub-assembly to rotate freely within the washer. Also, the hub/head sub-assembly has ports and clamps for removably receiving spray arm sub-assemblies. This way, the spray arms may be quickly and easily removed for repair and replacement. In addition, because the ball-bearing mount is not enclosed within the hub/head assembly, the bearing is readily accessible for cleaning and maintenance and is also easily removable for repair or replacement.

This application claims priority from U.S. Provisional Patent Application Serial No. 60/363,108, entitled “Spray Arm Hub/Head for Ware Washer”, which was filed on Mar. 7, 2002, the disclosure of which is herein incorporated by reference.

### BACKGROUND OF THE INVENTION

1. Field of the Invention

This invention relates generally to automatic ware washers (e.g. dishwashers) for commercial kitchens and cafeterias. More specifically, this invention relates to a ball-bearing spray assembly for ware washers with detachable spray arms.

2. Related Art

American Dish Service (ADS) of Edwardsville, Kans., USA, manufactures ware washing equipment. ADS offers its model HT-25 with a ball-bearing-mounted stainless steel hub/head and spray arms assembly. In this model the hub/head and spray arms are welded together as one integral unit. Consequently, if a spray arm becomes bent, broken or plugged, the entire assembly must be removed for repair or replacement, adding to the operators' downtime and expense.

The Hobart Manufacturing Co. (Hobart) of Southgate, London, U.K., offers some of its ware washing models with hub/head and detachable spray arm sub-assemblies. In these Hobart models, the separate spray arm sub-assemblies are clamped into the hub/head sub-assembly which is a casting. However, there is no ball-bearing mount for the hub/head sub-assembly of these Hobart models. As a result, with this design approach, undue friction and wear develops at the point of contact between the wash water supply line and the rotating hub/head sub-assembly.

U.S. Pat. No. 6,044,853 (Payzant) teaches a batch type commercial dish washer in which spray arms are supported upon a bearing. A rotary hub encloses a bearing within a bearing compartment. This enclosed bearing hub is installed on a pedestal that provides a rotational axis for the spray arms. To clean the apparatus or interchange spray arms, the pedastal/hub unit must be disassembled.

Therefore, there is still a need in the ware washing field for a hub/head sub-assembly which is ball-bearing-mounted and has detachable spray arm sub-assemblies so that these components are readily accessible for cleaning and maintenance. This invention addresses that need.

### SUMMARY OF THE INVENTION

The invention is a spray assembly for a high-temperature, automatic ware washer. The hub/head sub-assembly of the invention is mounted to the inlet water line via a bearing coupling. Preferably, the bearing coupling comprises a double-ball-bearing. The bearing coupling is non-integral with the hub assembly and functions independently of the hub to provide a rotational platform for the spray assembly. The attachment of the hollow bearing coupling to the inlet supply line and spray assembly at its upper and lower ends, respectively, rotatably secures the assembly within the ware washer and allows fluid passage from the supply line to the hollow spray hub and arms. The independent and non-enclosed ball-bearing coupling may be readily detached from the inlet supply line and/or spray assembly which provides access to the bearing for cleaning and maintenance. Also, the hub/head sub-assembly has ports and clamps for removably receiving spray arm sub-assemblies. This way, the spray arms may be quickly and easily removed for repair and replacement.

### BRIEF DESCRIPTION OF THE DRAWINGS

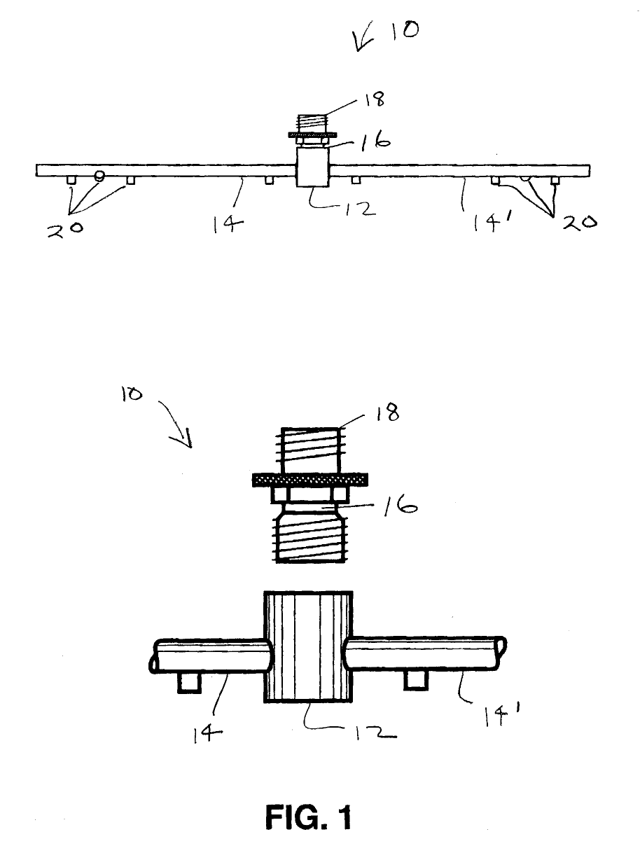

1. FIG. 1 (prior art) is a perspective view of an ADS Model HT-25 ball-bearing mounted hub/head and integral two (2) spray arm assembly.

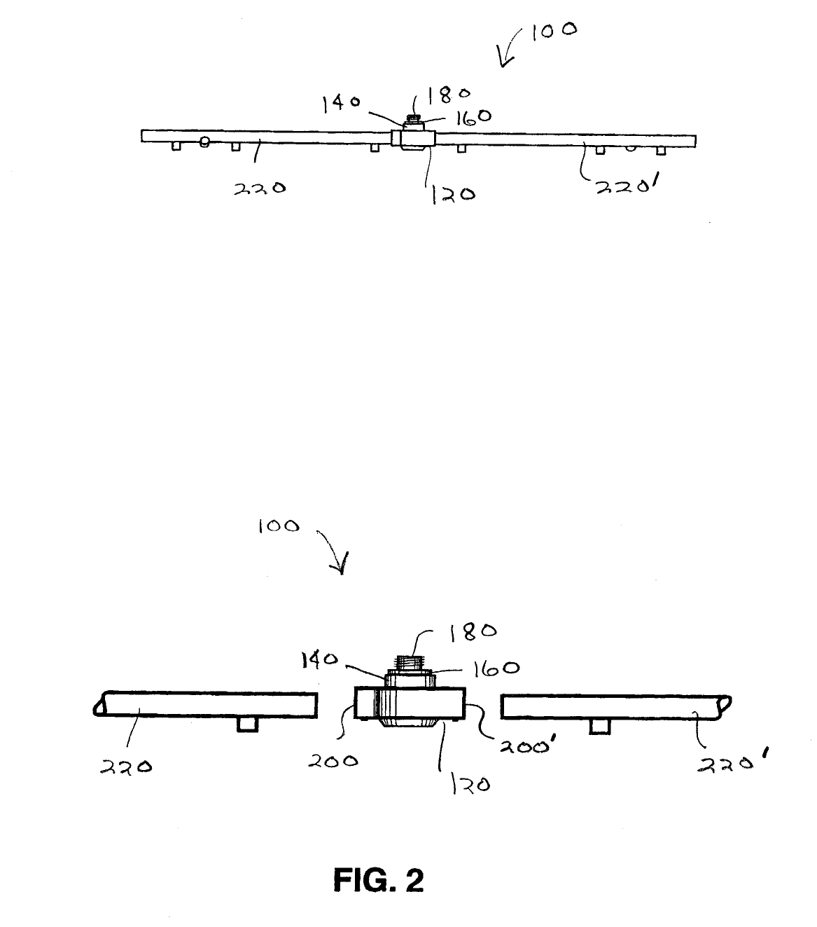

2. FIG. 2 (prior art) is a perspective view of a Hobart hub/head sub-assembly with two (2) separate, removable spray arm sub-assemblies.

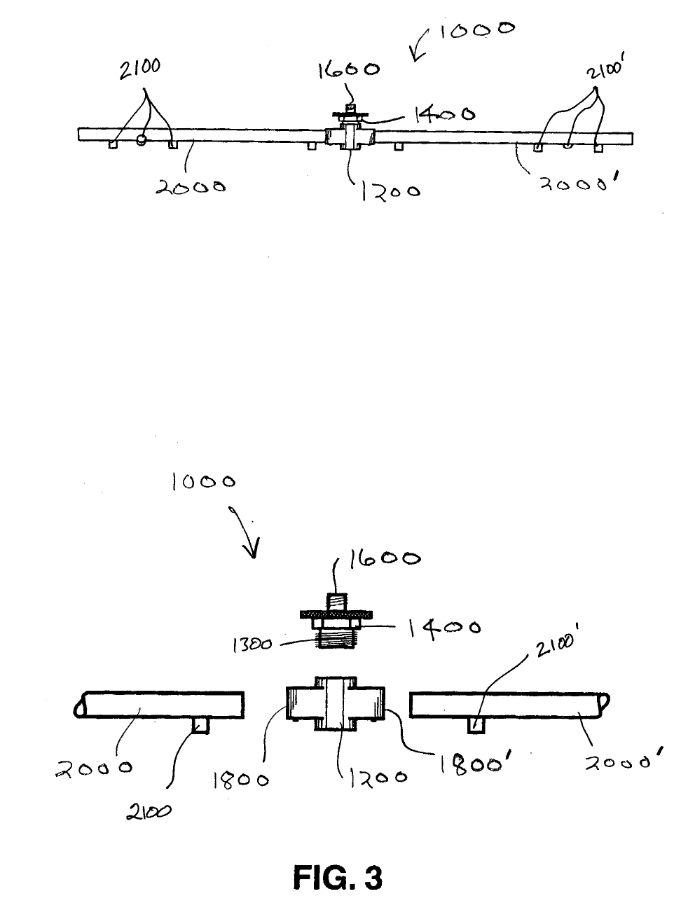

3. FIG. 3 (present invention) is a perspective view of one embodiment of the present invention.

4. FIG's 4-7 (present invention) are detail views of components of the spray arm hub/head of the present invention.

### DESCRIPTION OF THE PREFERRED EMBODIMENTS

Referring to the Figures, two (2) prior art devices are depicted in FIG. 1 and FIG. 2. FIG. 1 schematically depicts a prior art ADS model HT-25 device 10. The ADS HT-25 has a ball-bearing mounted hub/head 12 and integral two (2) spray arms 14 & 14′. Hub/head 12 has a single ball-bearing mount 16, and the ball-bearing mount 16 is connected to and supported by water supply inlet 18. Spray arms 14 & 14′ have outlet nozzles 20.

FIG. 2 schematically depicts a prior art Hobart device 100 with hub/head casting 120 and inlet nozzle mount 140 which rotates relative to hub/head 120 on a bushing 160. The inlet nozzle mount 140 is connected to and supported by water inlet supply 180. The Hobart hub/head has two (2) ports 200 & 200′ for releasably receiving and securing spray arms 220 & 220′, respectively.

FIG. 3 depicts an embodiment 1000 of the present invention. The spray assembly preferably comprises a hub, a plurality of spray arms and a ball-bearing mount. Within the ware washing unit, the hub/head sub-assembly 1200 with ball-bearing mount 1400 is connected to and supported by the inlet water supply. The ball-bearing mount comprises a double-ball-bearing coupling with an upper 1600 and lower 1300 threaded end which may be screwed into the inlet water supply (not shown) and the spray assembly hub 1200, respectively. Hub/head sub-assembly 1200 has two (2) ports 1800 & 1800′ for releasably receiving and securing spray arms 2000 & 2000′. In the preferred embodiment, spray arms 2000 & 2000′ include a plurality of spaced apart nozzles 2100 & 2100′ for distributing liquids throughout the ware washing unit.

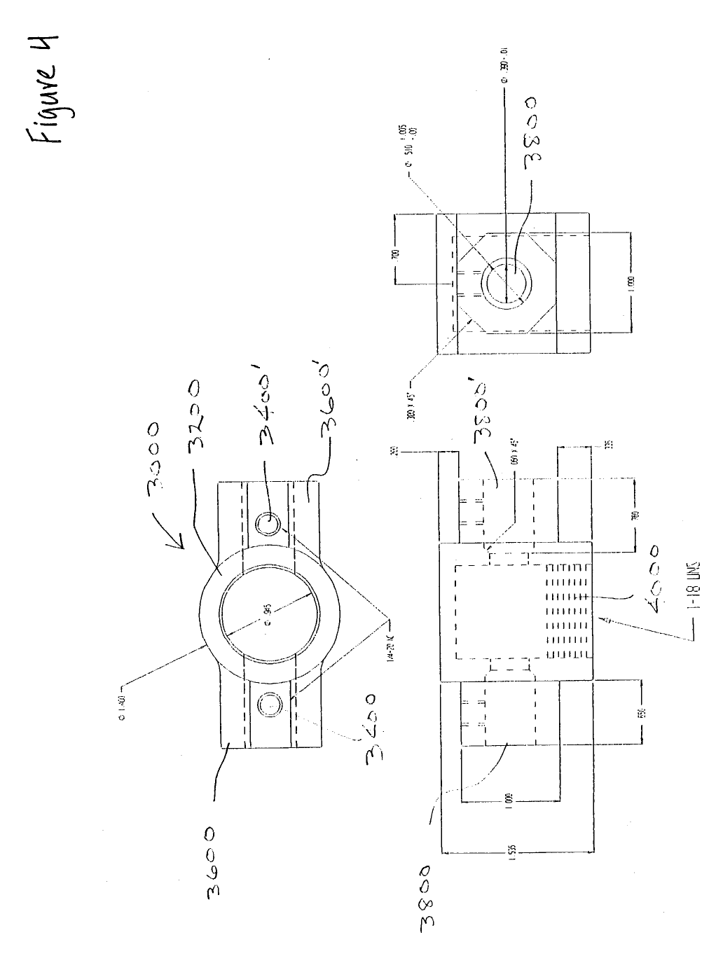

Referring to FIGS. 4 through 7, several detailed composite views of components of the spray arms and hub/head assembly of the present invention are shown.

FIG. 4 depicts three (3) views of the housing of the hub/head of the present invention. Counterclockwise from the top left of the figure, a preferred housing of the invented hub/head is shown from the bottom, front, and side. As shown in FIG. 4, the hub/head 3000 has a generally cylindrical hollow core 3200 with two (2) hollow side arms extending laterally from the cylindrical core. Preferably, the side arms include openings 3400 & 3400′ for receiving set screws. At least one opening for receiving a set screw exists in each side arm 3600 & 3600′, respectively. At the distal end of each side arm, port openings 3800 & 3800′ preferably receive and secure spray arms (not shown). In the preferred embodiment, the spray arms are removable. The spray arms are preferably inserted into the port openings and secured therein with set screws inserted in the two (2) openings 3400 & 3400′. Preferably, hub/head 3000 has an inlet port 4000 at its base which is threaded for receiving and securing threaded end 1300 of the hollow ball-bearing coupling 1400. The hollow bearing coupling passes liquids into the hollow spray hub and arms for distribution throughout the ware washer and provides a basis for rotation of the spray assembly.

In previous configurations, a ball-bearing has been enclosed within the spray hub to facilitate rotation of the spray assembly. For example, Payzant, in column 3, lines 57-65, provides an enclosed bearing compartment within a spray hub in which a bearing is located. To access the bearing, the hub must be disassembled to expose the bearing compartment. According to the present invention, a bearing is not substantially enclosed within the hub. Preferably, the hollow ball-bearing coupling 1400 of the present invention is substantially non-integral with the spray hub 1200 and functions independently of the hub to promote rotation of the spray assembly. To secure the rotating assembly within a ware washing unit, threaded end 1600 of the bearing coupling 1400 is threaded into the inlet water supply and threaded end 1300 is screwed into the spray hub 1200. This way, the hollow bearing coupling rotatably links the inlet water supply (not shown) and the hub/head 1200 so that the spray assembly, including hub head 1200 and spray arms 2000 & 2000′, may effectively receive and distribute cleansing liquids throughout the ware washing unit. The fixed inlet water line supports and secures the rotating assembly within the washer.

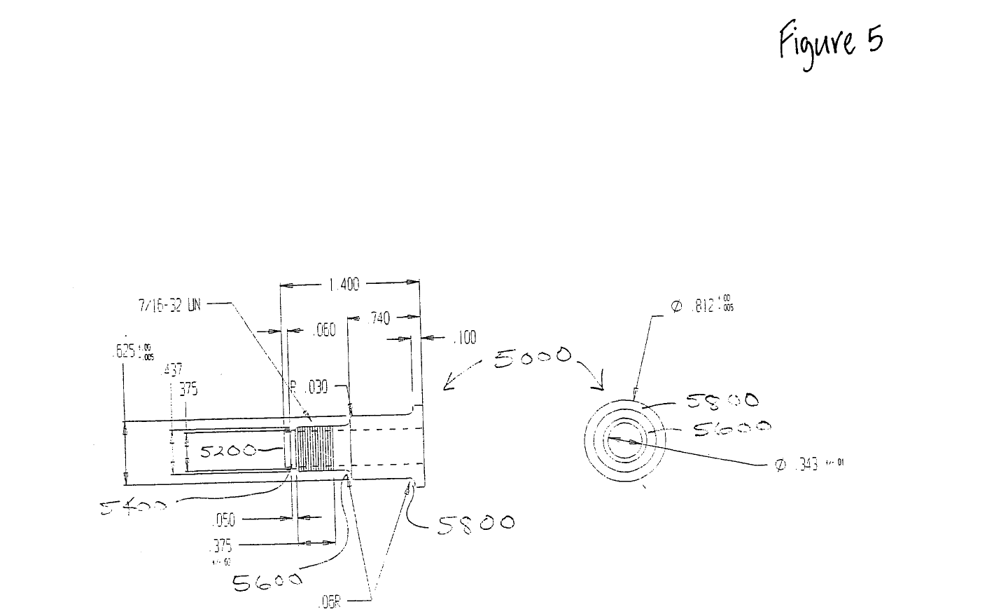

FIG. 5 depicts two (2) views (side and top views) of the inner sleeve of the hub/head of the present invention left to right from the left of the drawing. The inner sleeve 5000 preferably includes an externally threaded top end 5300 with a distal groove 5400 for receiving a retainer chip (not shown). The external surface of sleeve 5000 has a medial shoulder 5600 and a distal shoulder 5800 of diameter greater than the diameter of the medial shoulder. A first bearing race (not shown) cooperates with the medial shoulder 5600. A second bearing race (also not shown) cooperates with the distal shoulder 5800.

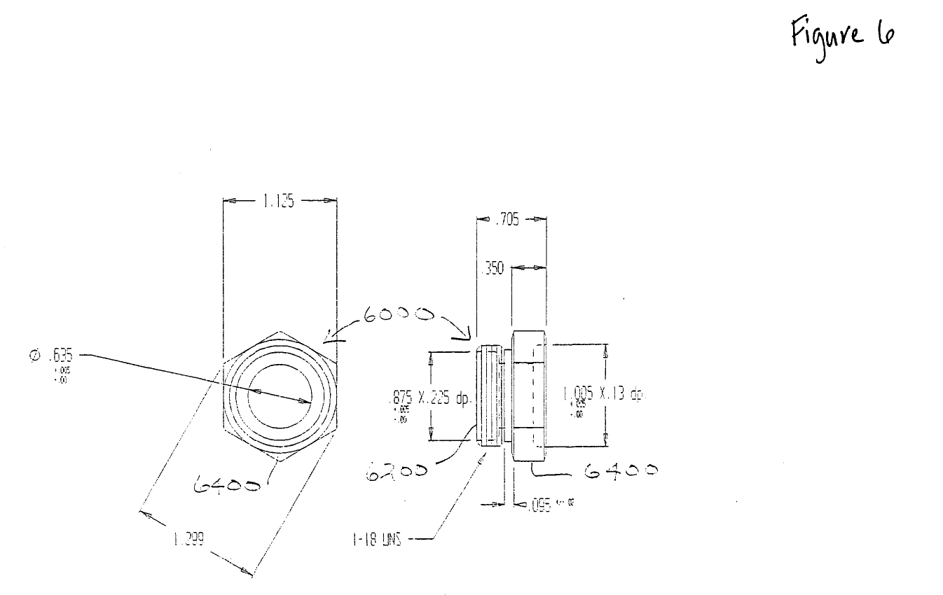

FIG. 6 depicts two (2) views (bottom and side views) of the bearing nut 6800 of the hub/head of the present invention left to right from the left of the drawing. Bearing nut 6000 has an externally threaded distal end 6200 for receiving and securing top inlet port 4000 of the hub/head 3000 of FIG. 4. Bearing nut 6000 surrounds the bottom end of the inner sleeve 5000 of FIG. 5. Bearing nut 6000 has two (2) bearing rods (not shown). One bearing rod interacts with medial shoulder 5600, and the other bearing rod interacts with distal shoulder 5800 of FIG. 5. Also, bearing nut 6000 has hexagonal top end 6400 to help make up the threaded connection between bearing nut distal end 6200 and top inlet port 4000 of the hub/head 3000.

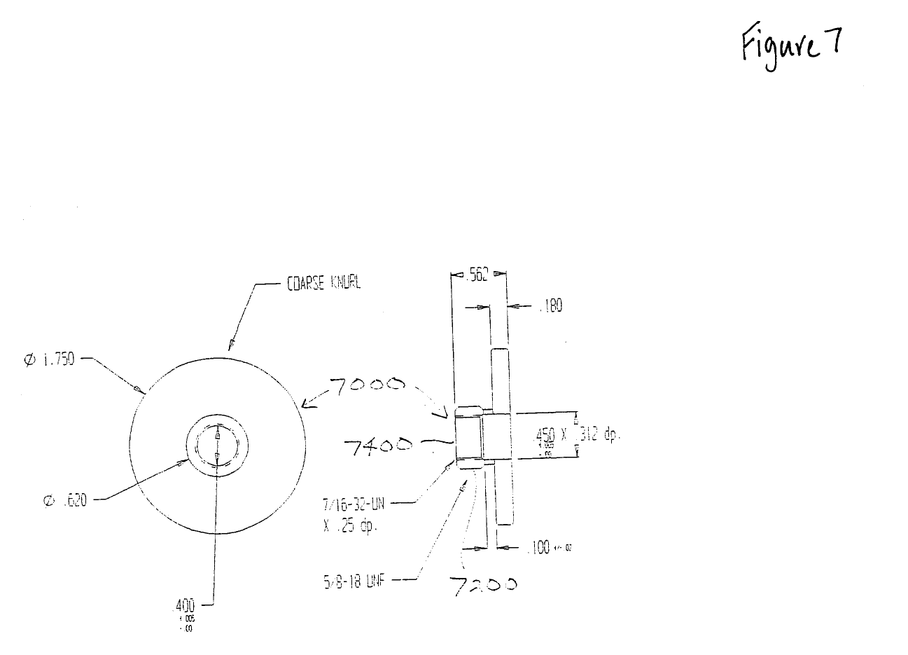

FIG. 7 depicts two (2) views (bottom and side views) of the adapter nut 7000 of the present invention left to right from the left of the drawing. Adapter nut 7000 has nut 7200 on distal end 7400. Nut 7200 surrounds and cooperates with the externally threaded top end 5200 of sleeve 5000 shown in FIG. 5 to secure the sleeve 5000, bearing nut 6000 and adapter nut 7000 together as one, freely rotating unit. The adapter nut 7000 has a proximal threaded connection (not shown) for connecting the sleeve, bearing nut and adapter nut sub-assembly to the inlet water line (not shown) for supporting and securing the spray arm hub/head within the ware washer.

Although this invention has been described above with reference to particular means, materials and embodiments, it is to be understood that the invention encompasses all alternatives within the broad scope of the following claims.

I claim:

1. A rotating spray assembly for high-temperature ware washers comprising:
a spray hub fitted with removable spray arms for distributing liquids to items within the ware washer; and
a bearing mount between an inlet water supply and the spray hub adapted to facilitate rotation of the spray assembly within the ware washer.

2. A rotating spray assembly for high-temperature ware washers comprising:
a spray hub with a hollow core and a plurality of laterally extending arms wherein said hub is adapted to receive liquids from a fixed inlet supply and distribute said liquids to a plurality of spray arms extending laterally from ports at the distal ends of said arm segments;
a plurality of spray arms with spaced apart nozzles adapted to distribute liquids to items situated within the ware washer; and
a substantially non-enclosed bearing, non-integral with said spray hub, adapted to facilitate spinning of the hub and spray arms wherein said bearing comprises a hollow ball-bearing coupling, with threaded upper and lower ends, removably and rotatably secured between said hub and said inlet supply of a ware washing unit.
